(19) United States
(12) Patent Application Publication
(10) Pub. No.: US 2013/0121323 A1
(43) Pub. Date: May 16, 2013

(54) Method for Receiving Frames in a Wireless Local Area Network

(71) Applicants: Jorma LILLEBERG, Oulu (FI); Wei LI, Oulu (FI)

(72) Inventors: Jorma LILLEBERG, Oulu (FI); Wei LI, Oulu (FI)

(73) Assignee: Renesas Mobile Corporation

(21) Appl. No.: 13/297,409

(22) Filed: Nov. 16, 2011

(30) Foreign Application Priority Data
Nov. 14, 2011 (GB) 1119629.2

(51) Int. Cl. H04W 84/02

(52) U.S. Cl. 370/338

(57) ABSTRACT

First and second frames are received by a wireless receiver. Modulation symbols in the first frame are determined and stored. If a cyclic redundancy check failure is determined for the first frame, the frame is not passed to medium access control. Modulation symbols in the second frame are determined and stored and a correlation factor is computed between the at least two modulation symbols from the first frame and the at least two modulation symbols from the second frame. If the receiver determines that the correlation factor exceeds a predefined threshold, it performs maximum ratio combining for modulation symbols from the first frame and modulation symbols from the second frame in order to obtain a combined frame. The combined frame is demodulated and cyclic redundancy check success is determined for the combined frame.

### BACKGROUND OF THE INVENTION

1. Field of the Invention

The invention relates to Wireless Local Area Networks (WLAN) and a method for the receiving of frames and the combining of received frames in a wireless local area network.

2. Description of the Related Art

Since 1999, the Wireless Local Area Network (WLAN) system based on the Institute of Electrical and Electronics Engineers (IEEE) 802.11 standard has been widely utilized. It simply extends the fixed network to wireless connections with additional support for Medium Access Control (MAC) and Physical layers. Hence, people are able to deploy and establish a network in a local area rapidly and freely. All WLAN devices are working on an unlicensed frequency band, which is shared by different other devices, therefore, the performance of a WLAN is mainly limited by the interference, which is due to the simultaneous transmissions within the area of the WLAN. To overcome the problem and increase the link reliability, WLAN systems use a simple retransmission scheme with Automatic Repeat Query (ARQ) feedback from the receiving station. ARQ is an error-control method for data transmission, which uses acknowledgements and timeouts to achieve reliable data transmission over an unreliable service. If a sender does not receive an acknowledgment before the timeout, the sender usually retransmits a frame until the sender receives an acknowledgment or exceeds a predefined number of retransmissions attempts. Considering that the retransmitted data must be the same as the previously one, the retransmission diversity could be utilized to increase the transmission reliability by combining the two received packets together. Aiming at this purpose, many schemes have been proposed to utilize the retransmission diversity. However those proposals cannot work properly in the practical systems due to some drawbacks. Patent application US 2003/0112780 discloses a Maximum Ratio Packet Combining (MRPC) method. In US 2003/0112780, when a first station attempts to send a frame to the second station by transmitting the packet first time and repeating the transmission afterwards, the second station compares several fields between the two received frames. If they had the same values, the two frames were combined via MRPC. However, since the received frames have failed to pass the Cyclic Redundancy Check (CRC) already, just comparing those specified fields is not a proper way to recognize the retransmitted frame. However, another problem with the method disclosed in US 2003/0112780 is that in some cases transmitting stations use scrambling of the frames before modulation, for example, to distinguish between transmitting wireless Access Points (AP). This may be the case, for example, when Orthogonal Frequency Division Multiplexing (OFDM) is used by the wireless APs. The result of the frame scrambling for same data varies between frames regardless of whether a frame is a retransmission or not. The scrambling renders the combining efforts futile.

It would be beneficial to be able to use retransmission diversity in a WLAN even when frame scrambling is used by the wireless APs.

### SUMMARY OF THE INVENTION

According to an aspect of the invention, the invention is a method, comprising: receiving a first frame by a wireless receiver; determining at least two first modulation symbols from at least one first signal carrying the first frame; storing the at least two first modulation symbols to a memory; determining a cyclic redundancy check failure for the first frame; receiving a second frame by the wireless receiver; determining at least two second modulation symbols from at least one second signal carrying the second frame; storing the at least two second modulation symbols in the second frame to the memory; computing a correlation factor between the at least two first modulation symbols and the at least two second modulation symbols; determining that the correlation factor exceeds a predefined threshold; performing a symbol-wise combining of the at least two first modulation symbols and the at least two second modulation symbols in order to obtain a combined frame; demodulating the combined frame; and determining cyclic redundancy check success for the combined frame.

According to a further aspect of the invention, the invention is a method, comprising: scrambling the frame with a pseudorandom number sequence from a pseudorandom number generator in a wireless transmitter to produce a first scrambled frame; storing a seed value used in generating the pseudorandom number sequence to a memory; transmitting the first scrambled frame from the wireless transmitter; determining timer expiry for an acknowledgement for the scrambled frame in the wireless transmitter; reinitializing the pseudorandom number generator with the seed value from the memory; scrambling the frame with the pseudorandom number sequence from the pseudorandom number generator in the wireless transmitter to produce a second scrambled frame; and transmitting of the second scrambled frame.

According to a further aspect of the invention, the invention is a wireless receiver comprising: a memory; and at least one processor configured to receive a first frame, to determine at least two first modulation symbols from at least one first signal carrying the first frame, to store the at least two first modulation symbols to a memory, to determine a cyclic redundancy check failure for the first frame, to receive a second frame by the wireless receiver, to determine at least two second modulation symbols from at least one second signal carrying the second frame, to store the at least two second modulation symbols in the second frame to the memory, to compute a correlation factor between the at least two first modulation symbols and the at least two second modulation symbols, to determine that the correlation factor exceeds a predefined threshold, to perform a symbol-wise combining of the at least two first modulation symbols and the at least two second modulation symbols in order to obtain a combined frame, to demodulate the combined frame, and to determine cyclic redundancy check success for the combined frame.

According to a further aspect of the invention, the invention is a wireless transmitter comprising: a memory; and at least one processor configured to scramble the frame with a pseudorandom number sequence from a pseudorandom number generator to produce a first scrambled frame, to store a seed value used in generating the pseudorandom number sequence to the memory, to transmit the first scrambled frame, to determine timer expiry for an acknowledgement for the scrambled frame, to reinitialize the pseudorandom number generator with the seed value from the memory, to scramble the frame with the pseudorandom number sequence from the pseudorandom number generator to produce a second scrambled frame, and to transmit the second scrambled frame.

According to a further aspect of the invention, the invention is a wireless receiver comprising: means for receiving a first frame by a wireless receiver; means for determining at least two first modulation symbols from at least one first signal carrying the first frame; means for storing the at least two first modulation symbols to a memory; means for determining a cyclic redundancy check failure for the first frame; means for receiving a second frame by the wire less receiver; means for determining at least two second modulation symbols from at least one second signal carrying the second frame; means for storing the at least two second modulation symbols in the second frame to the memory; means for computing a correlation factor between the at least two first modulation symbols and the at least two second modulation symbols; means for determining that the correlation factor exceeds a predefined threshold; means for performing a symbol-wise combining of the at least two first modulation symbols and the at least two second modulation symbols in order to obtain a combined frame; means for demodulating the combined frame; and means for deter mining cyclic redundancy check success for the combined frame.

According to a further aspect of the invention, the invention is a wireless transmitter comprising: means for scrambling the frame with a pseudorandom number sequence from a pseudorandom number generator in a wireless transmitter to produce a first scrambled frame; means for storing a seed value used in generating the pseudorandom number sequence to a memory; means for transmitting the first scrambled frame from the wireless transmitter; means for determining timer expiry for an acknowledgement for the scrambled frame in the wireless transmitter; means for reinitializing the pseudorandom number generator with the seed value from the memory; means for scrambling the frame with the pseudorandom number sequence from the pseudorandom number generator in the wireless transmitter to produce a second scrambled frame; and means for transmitting of the second scrambled frame.

According to a further aspect of the invention, the invention is a computer program comprising code adapted to cause the following when executed on a data-processing system: receiving a first frame by a wireless receiver; determining at least two first modulation symbols from at least one first signal carrying the first frame; storing the at least two first modulation symbols to a memory; determining a cyclic redundancy check failure for the first frame; receiving a second frame by the wireless receiver; determining at least two second modulation symbols from at least one second signal carrying the second frame; storing the at least two second modulation symbols in the second frame to the memory; computing a correlation factor between the at least two first modulation symbols and the at least two second modulation symbols; determining that the correlation factor exceeds a predefined threshold; performing a symbol-wise combining of the at least two first modulation symbols and the at least two second modulation symbols in order to obtain a combined frame; demodulating the combined frame; and determining cyclic redundancy check success for the combined frame.

According to a further aspect of the invention, the invention is a computer program product comprising the computer program.

According to a further aspect of the invention, the invention is a computer program comprising code adapted to cause the following when executed on a data-processing system: scrambling the frame with a pseudorandom number sequence from a pseudorandom number generator in a wireless transmitter to produce a first scrambled frame; storing a seed value used in generating the pseudorandom number sequence to a memory; transmitting the first scrambled frame from the wireless transmitter; determining timer expiry for an acknowledgement for the scrambled frame in the wire less transmitter; reinitializing the pseudorandom number generator with the seed value from the memory; scrambling the frame with the pseudorandom number sequence from the pseudorandom number generator in the wireless transmitter to produce a second scrambled frame; and transmitting of the second scrambled frame.

According to a further aspect of the invention, the invention is a computer program product comprising the computer program.

According to a further aspect of the invention, the invention is system comprising the wireless receiver and the wireless transmitter.

In one embodiment of the invention, the step of performing the symbol-wise combining of the at least two first modulation symbols and the at least two second modulation symbols comprises the performing of a symbol-wise maximum ratio combining of the at least two first modulation symbols and the at least two second modulation symbols. By the maximum ratio combining may be understood diversity combining in which signals from each channel, for example, in this case the channel used to receive the at least one first signal and the at least one second signal, are added together, a gain of each channel is made proportional to the root means squared signal level and inversely proportional to the mean square noise level in that channel, and different proportionality constants are used for each channel. It is also known as ratio-squared combining and pre-detection combining.

In one embodiment of the invention, the at least two first modulation symbols are stored to the memory as a first ordered list or table. The at least two second modulation symbols are stored to the memory as a second ordered list or table. The step of per forming the symbol-wise combining for the at least two first modulation symbols and the at least two second modulation symbols further comprises for each respective modulation symbol in the lists: taking a first modulation symbol among the at least two first modulation symbols and taking a second respective modulation symbol among the at least two second modulation symbols and combining the first modulation symbol and the second modulation symbol to yield a combined modulation symbol. The combining may be maximum ratio combining, that is, maximal ratio combining. The combining may comprise multiplying the first modulation symbol with a complex conjugate a frequency channel response or channel coefficient of a channel on which the first signal is received and multiplying the second modulation symbol with a complex conjugate of a frequency channel response or channel coefficient of the channel on which the second signal is received. The combined modulation symbol may be further divided by squared noise power at the antenna, or squared combined noise power at the antennas used, to receive the first and the second signals. The combined modulation symbol may be normalized, for example, by dividing by 2, that is, the number of combined symbols.

In one embodiment of the invention, the step of performing the symbol-wise combining for the at least two first modulation symbols and the at least two second modulation symbols further comprises skipping at least one modulation symbol and taking at least one modulation symbol to the combined frame directly from either the at least two first modulation symbols or the at least two second modulation symbols. The at least one modulation symbol skipped in the symbol-wise combining is taken from the corresponding position in either the at least two first modulation symbols or the at least two second modulation symbols. At least one modulation symbol skipped may correspond to at least one field that is changed in the retransmission. The at least one field may comprise at least one of a frame check sequence, a cyclic redundancy check value and a retransmit indicator.

In one embodiment of the invention, the method further comprises providing the combined frame from the wireless receiver to at least one processor.

In one embodiment of the invention, the step of determining at least two first modulation symbols from at least one first signal carrying the first frame further comprises: performing a discrete Fourier transform for the at least one first signal on at least one subcarrier to obtain the at least two first modulation symbols.

In one embodiment of the invention, the step of determining at least two second modulation symbols from at least one second signal carrying the first frame further comprises: performing a discrete Fourier transform for the at least one second signal on at least one subcarrier to obtain the at least two second modulation symbols.

In one embodiment of the invention, the method further comprises: determining a frequency channel response on the at least one subcarrier; and eliminating the frequency channel response in the symbol-wise combining of the at least two first modulation symbols and the at least two second modulation symbols.

In one embodiment of the invention, the method further comprises: determining a first frequency channel response associated with a first channel for receiving the first frame; determining a second frequency channel response associated with a second channel for receiving the second frame; and eliminating the first frequency channel response and the second frequency channel response in the symbol-wise combining of the at least two first modulation symbols and the at least two second modulation symbols.

In one embodiment of the invention, the at least two modulation symbols in the first frame or the second frame are determined by the receiver from a signal comprising the first frame or the second frame, respectively. The determination may comprise performing discrete Fourier transform followed by equalization to compensate for channel effects.

In one embodiment of the invention, the wire less transmitter comprises a chip or a chipset.

In one embodiment of the invention, the wireless receiver comprises a chip or a chipset.

In one embodiment of the invention, the method further comprises providing the combined frame to at least one processor from the wireless receiver.

In one embodiment of the invention, the method further comprises performing a discrete Fourier transform for signals on at least two subcarriers to obtain the at least two modulation symbols.

In one embodiment of the invention, the method further comprises determining frequency channel response on the at least two subcarriers; and eliminating the frequency channel response in the maximum ratio combining.

In one embodiment of the invention, the method further comprises determining frequency channel response associated with a channel for receiving the frame; and eliminating the frequency channel response in the maximum ratio combining.

In one embodiment of the invention, the wireless receiver is comprised in a wireless local area network station.

In one embodiment of the invention, the wireless receiver is comprised in a wireless local area network wireless access point.

In one embodiment of the invention, the wireless receiver is an Orthogonal Frequency Division Multiple Access receiver.

In one embodiment of the invention, the wireless receiver is a Direct Sequence Spread Spectrum receiver.

In one embodiment of the invention, the wire less receiver or the wireless transmitter comprises a mobile terminal, for example a, mobile handset.

In one embodiment of the invention, the wireless receiver or the wireless transmitter comprises a semiconductor circuit, a chip or a chipset.

In one embodiment of the invention, in step of performing maximum ratio combining for the at least two modulation symbols from the first frame and the at least two modulation symbols from the second frame at least one modulation symbol is obtained directly from the second frame only. This means that the maximum ratio combining is not performed for the at least one modulation symbol, but the at least one modulation symbol is taken from the second frame. This may be used for modulation symbols carrying information on, for example, the retry bit in the frame header of the second frame and the frame check sequence carrying the CRC.

In one embodiment of the invention, the at least two modulation symbols of the first frame and the second frame also comprise information on the Physical Layer Convergence Protocol (PLOP) header. In this way the information on modulation scheme and coding rate is preserved.

In one embodiment of the invention, the correlation factor is computed after doing synchronization.

In one embodiment of the invention, the computer program is stored on a computer readable medium. The computer readable medium may be, but is not limited to, a removable memory card, a removable memory module, a magnetic disk, an optical disk, a holographic memory or a magnetic tape. A removable memory module may be, for example, a USB memory stick, a PCMCIA card or a smart memory card.

The embodiments of the invention described hereinbefore may be used in any combination with each other. Several of the embodiments may be combined together to form a further embodiment of the invention. A method, a base station, an apparatus, a computer program, a computer program product or system to which the invention is related may comprise at least one of the embodiments of the invention described hereinbefore.

It is to be understood that any of the above embodiments or modifications can be applied singly or in combination to the respective aspects to which they refer, unless they are explicitly stated as excluding alternatives.

The benefits of the invention are related to improved quality of service from user perspective, reduced number of retransmissions and the support for retransmission diversity.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates a transmitting station and a receiving station in one embodiment of the invention;

FIG. 2 is a block diagram illustrating a station comprising an OFDM transmitter and a station comprising an OFDM receiver and the flow of transmitted and received data in one embodiment of the invention;

FIG. 3 is a block diagram illustrating a station comprising a DSSS transmitter and a station comprising a DSSS receiver and the flow of transmitted and received data in one embodiment of the invention;

FIG. 4 is a flow chart illustrating a method for combining received frames in one embodiment of the invention; and

FIG. 5 is a flow chart illustrating a method for retransmitting a frame.

### DETAILED DESCRIPTION OF THE EMBODIMENTS

Reference will now be made in detail to the embodiments of the present invention, examples of which are illustrated in the accompanying drawings.

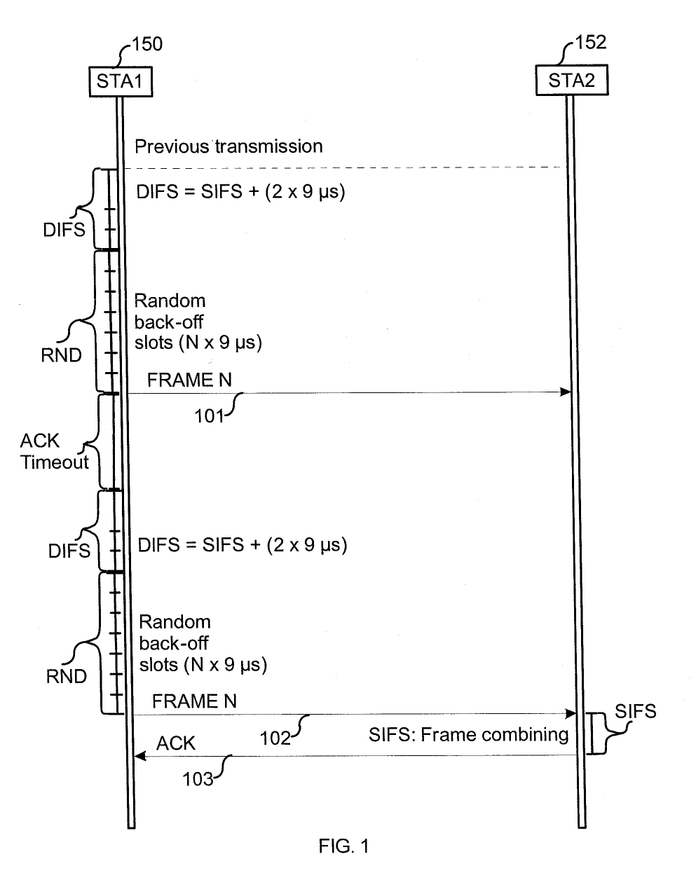

FIG. 1 illustrates a transmitting station 150 and a receiving station 152. Transmitting station 150 may be Wireless Access Point (WAP). Receiving station 152 may be a mobile node, for example, a laptop computer comprising a Wireless Local Area Network (WLAN) transceiver. The roles may also be reversed and receiving station 152 may be a WAP, whereas transmitting station 150 may be a mobile node. The starting point in FIG. 1 is that station 150 waits until the transmission medium is free from previous transmission. Station 150 waits a Distributed Coordination Function Inter-frame Spacing (DIFS) time, which is equal to Short Inter-frame Spacing (SIFS) plus two times 9 ps. In the IEEE 802.11n the SIFS is 16 ps and, therefore, DIFS is 34 ps. After that station 150 picks a random number K₁ and waits further K₁ times 9 ps, which is illustrated in FIG. 1 with reference abbreviation RND. The time RND is called a random back-off time. It is in average 67 ps. After the time RND, station 150 transmits a frame which has a sequence number N, as illustrated with arrow 101. Station 152 receives the frame N, but the frame N is assumed to not to pass the CRC check at station 152. Therefore, station 152 does not transmit an acknowledgement to station 150. However, station 152 stores frame N received in reception illustrated with arrow 101 to a memory of the station 152. Station 150 waits for an acknowledgement for the frame N until the timer for acknowledgement expires. After the timer expiry, station 150 determines that the transmission medium is free. Station 150 waits the DIFS time and picks a second random number K₂ and waits further K₂ times 9 ps, which is illustrated in FIG. 1 with reference abbreviation RND. Thereupon, station 150 sends a retransmission of frame N, as illustrated with arrow 102. If the retransmission of frame N does not pass CRC check, station 152 also stores frame N received in reception illustrated with arrow 102 in the memory of station 152. Station 102 computes a correlation factor between reception 101 and reception 102 of the frame N. If the correlation factor exceeds a predefined threshold value, station 152 combines the signals received in reception 101 and reception 102 of the frame N. If the combined signals yield a frame which passes the CRC check, the information regarding receptions 101 and 102 may be cleared from the memory of station 152 and the frame may be passed to higher protocol layers in station 152. Station 152 waits for a SIFS time and transmits and acknowledgement to station 150 regarding frame N, as illustrated with arrow 103.

In one embodiment of the invention, the acknowledgement may be sent as part of a block acknowledgement.

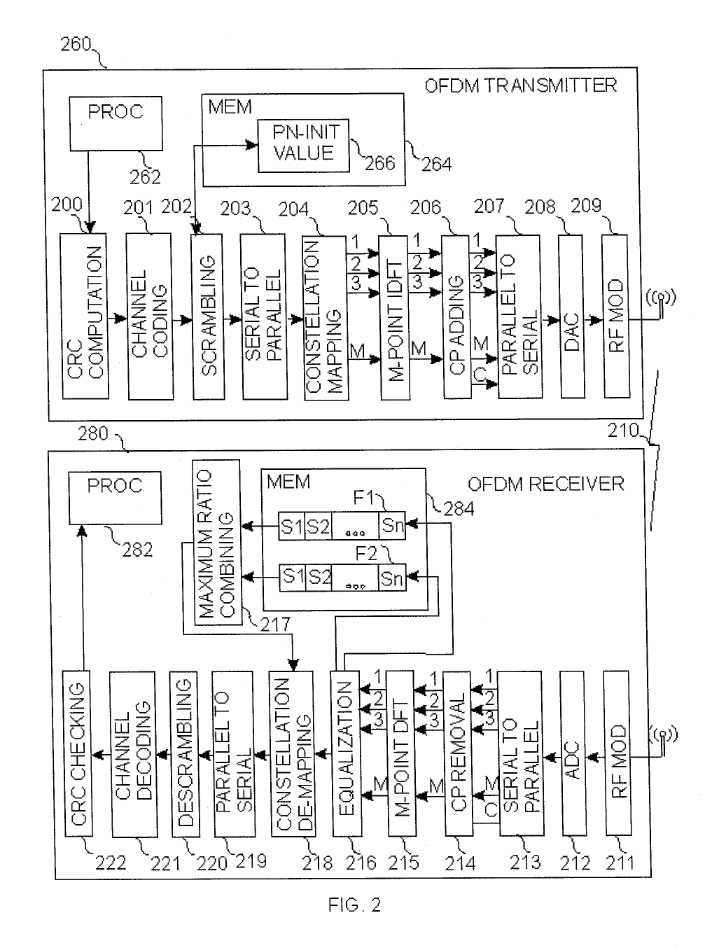

FIG. 2 is a block diagram illustrating a station comprising an OFDM transmitter and a station comprising an OFDM receiver and the flow of transmitted and received data in one embodiment of the invention.

An Orthogonal Frequency Division Multiplexing (OFDM) transmitter, referred to as, a transmitter 260 performs the transmission of an OFDM signal, whereas an OFDM receiver, referred to as, a receiver 280 performs the reception of an OFDM signal. Transmitter 260 may be located in a station 150 such as station 150 in FIG. 1. Receiver 280 may be located in a station such as station 152 illustrated in FIG. 1.

Transmitter 260 converts a binary data frame to a signal that is transmitted on a number of subcarriers. Signal processing is performed in stages illustrated in FIG. 2. The stages may be circuits that are part of a single combined circuit. The stages may also be separate interconnected circuits. Transmitter 260 comprises also at least one processor, for example, a processor 262 and a memory 264. The memory may be, for example, a Random Access Memory (RAM). The memory may also be, for example, a register file or a register.

The starting point in FIG. 2 is that processor 262 of transmitter 260 forms a binary data frame and provides it to stage 200. The binary data frame may be formed from a segment of a packet from a Medium Access Control (MAC) protocol layer.

In stage 200, the bits from a binary data frame are first used to compute a Cyclic Redundancy Check (CRC) code, also referred to as a Frame Check Sequence (FCS). The CRC code is appended or otherwise added to the frame. The resulting frame may be referred to as frame F1.

In stage 201, the frame F1 is coded using a channel code that is based on a selected Modulation and Coding Scheme (MCS) index, which is indicated to stage 201 from processor 262. The channel coding may provide redundancy that may be used to correct errors when the frame F1 is received.

In stage 202, the frame F1 is scrambled using a Pseudorandom Number (PN) sequence. The PN sequence is obtained from a PN generator (not shown). The PN generator is initialized with a seed value. For retransmitted frames the seed value is obtained from memory 264 which stores the seed value as a PN initialization seed value 266. The seed value is also transmitted as part of frame F1 header so that any receiver may perform descrambling. The seed value may be transmitted as part of High Throughput (HT) HT-Signal Physical Layer Convergence Protocol (PLCP) header. The purpose of the scrambling is, for example, to separate signals from different WAPs from each other and to eliminate the dependence of signal power spectrum upon the actual transmitted data.

In stage 203, the bits from frame F1 are segmented to blocks, the size of which in bits depends on the modulation scheme. For example, in the case of 16 QAM the block size is 4 bits and in the case of 64 QAM the block size is 6 bits. Each block from frame F1 is provided to stage 204.

In stage 204, the blocks are mapped to complex modulation symbols. A block of bits to be transmitted is modulated using, for example, Quadrature Phase Shift Keying (QPSK), 16 point Quadrature Amplitude Modulation (16 QAM) or 64 point Quadrature Amplitude Modulation (64 QAM) in constellation mapping stage 204. Constellation mapping stage 204 produces a number of parallel bit blocks represented in frequency domain as M complex valued modulation symbols.

At stage 205 an M-point Inverse Discrete Fourier Transform (IDFT) transforms the complex valued modulation symbols to M streams of complex time domain samples. The streams of complex time domain samples form a complex time domain signal, that is, a time domain signal for a subcarrier.

At stage 206 to the M streams of complex time domain samples is added a cyclic prefix C.

At stage 207 the M+1 streams of complex time domain samples are converted to a serial signal.

At stage 208 for the serial signal is applied digital-to-analog conversion to produce an analog signal.

At stage 209 the analog signal is modulated to a final transmission radio frequency and transmitted as a radio signal 210. Thereby, the frame F1 is transmitted. It is assumed that receiver 280 detects an error in frame F1 so that the data in frame F1 is later on retransmitted as frame F2 by transmitter 260.

Receiver 280 de-modulates the radio signal 210 at stage 211 to produce an analog signal. Receiver 280 also comprises at least one, for example, a processor 282 and a memory 284. The memory may be a Random Access Memory (RAM). The memory may also be, for example, a register file or a register.

At stage 212 for the analog signal is applied analog-to-digital conversion to produce a serial signal.

At stage 213 the serial signal is converted to M+1 streams of complex time domain samples. A stream represents a signal on a given subcarrier in the time domain.

At stage 214 M streams of complex time domain samples are produced for stage 215 thereby removing the cyclic prefix.

At stage 215 an M-point Discrete Fourier Transform (DFT) is applied for the M streams of complex time domain samples to produce complex subcarrier symbols. Thus, at stage 215 the streams of complex time domain samples are de-mapped to provide M complex valued modulation symbols.

At stage 216 the M complex valued modulation symbols are equalized using channel estimation information. The effects of the channel on the constellation are thereby at least partly cancelled. The M equalized complex valued modulation symbols are stored to memory 284 after stage 216. Thereby, the complex valued modulation symbols, which are illustrated in FIG. 2 as S1, S2 and Sn, where n is the number of complex valued modulation symbols, are stored and form the frames F1 and F2. If both frames F1 and F2 failed CRC checking later at stage 225 and the F2 is determined to be a retransmission of F1 using correlation determination at stage 217, the frames are combined using maximum ratio combining at stage 217. The correlation is determined, for example, by computing an Euclidean norm

$$c = \vert \frac{{\sum }_{i = 0}^{N} {y}_{i}^{r} {y}_{i}^{b *}}{N} \vert ,$$

wherein i is the modulation symbol index and superscript r denotes the currently received frame F2 and superscript b* denotes the complex conjugate of the previously received, buffered frame F1, and comparing the norm c to a predefined threshold value, for example ½. The maximum ratio combining is performed symbol wise for each respective modulation symbol of frames F1 and F2. The maximum ratio combining S_{c} may be computed, for example, for each modulation symbol with formula

$${S}_{C} = ( \frac{{s}_{RX} \overline{{h}_{RX}} / {σ}_{RX}^{2} + {s}_{B} \overline{{h}_{B}} / {σ}_{B}^{2}}{2} ) ,$$

wherein S_{c} denotes a symbol resulting from the combining of S_{RX}, denoting the symbol from currently received frame F2, and S_{B}, denoting the symbol from buffered frame F1, h̅_̅{̅R̅X̅}̅ is the complex conjugate of the channel coefficient on the channel from which the symbol from frame F2 was received, h̅_̅{̅B̅}̅ is the complex conjugate of the channel coefficient on the channel from which the symbol from frame F1 was received, and σ_{RX} and σ_{B} are the respective measured noise powers at the antennas, via which the symbols from frames F2 and F1 were received. A combined frame is produced. The complex valued modulation symbols from the stage 217 are provided for stage 218 for constellation de-mapping.

At stage 218, the constellation de-mapping produces a number of parallel bits from the M complex valued modulation symbols.

At stage 219, the parallel bits are converted to a series of outgoing bits.

At stage 220, the parallel bits are descrambled using the Pseudorandom Number (PN) sequence. The PN sequence is obtained from a PN generator. The PN generator is initialized with a seed value provided as part of the frame header from transmitter 260, in order to achieve successful descrambling.

In stage 221, the combined frame is decoded using the channel code based on the Modulation and Coding Scheme (MCS) used by transmitter 260.

In stage 220, the bits from a binary data frame are first used to compute a Cyclic Redundancy Check (CRC) code also referred to as a Frame Check Sequence (FCS). If the computed CRC does not match the received FCS, the frame is not passed to processor 282 for MAC protocol layer processing. Otherwise the frame is passed to processor 282 for MAC protocol layer processing.

The stages in transmitter 260 and receiver 280 may be circuits that are part of a single larger circuit. The stages may be combined in any way to produce a combined circuit.

Transmitter 260 may be comprised in, for example, a mobile node, user equipment, a handset, a cellular phone, a mobile terminal, an Application Specific Integrated Circuit (ASIC), a chip or a chipset.

Receiver 280 may be comprised in, for example, a mobile node, user equipment, a handset, a cellular phone, a mobile terminal, an Application Specific Integrated Circuit (ASIC), a chip or a chipset.

Transmitter 260 and receiver 280 may comprise multiple input or output antennas.

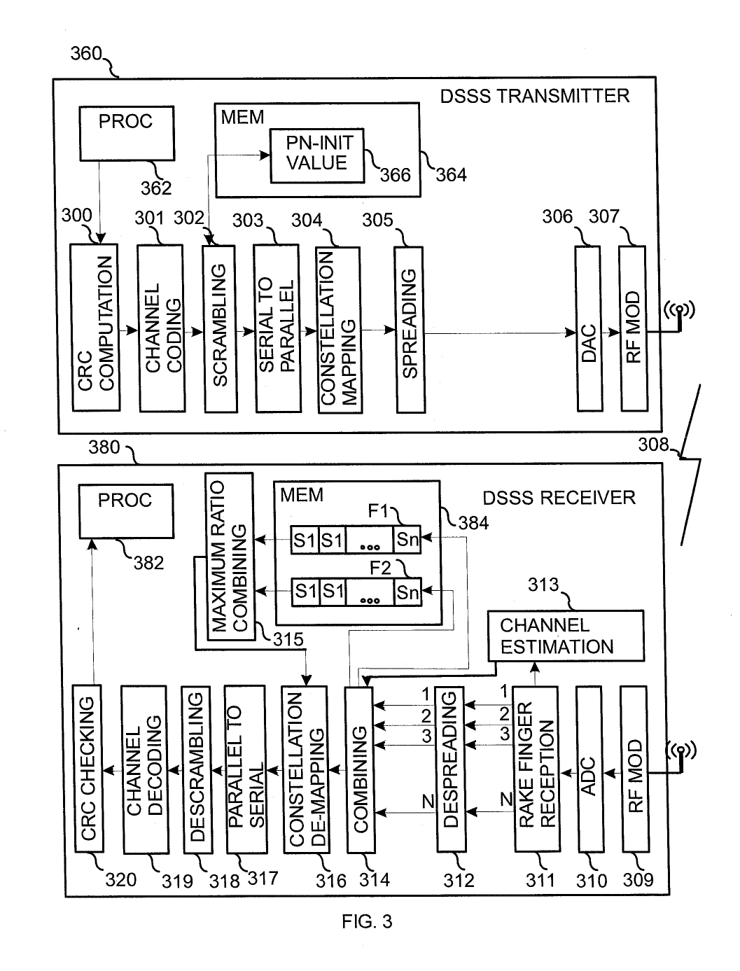

FIG. 3 is a block diagram illustrating a station comprising a DSSS transmitter and a station comprising a DSSS receiver and the flow of transmitted and received data in one embodiment of the invention. A Direct Sequence Spread Spectrum (DSSS) transmitter, referred to as, a transmitter 360 performs the transmission of a DSSS signal, whereas a DSSS receiver, referred to as, a receiver 380 performs the reception of a DSSS signal. Transmitter 260 may be located in a station 150 such as station 150 in FIG. 1. Receiver 280 may be located in a station such as station 152 illustrated in FIG. 1.

Transmitter 260 converts a binary data frame to a signal that is transmitted on as a direct sequence spread signal on a frequency band. Signal processing is performed in stages illustrated in FIG. 3. The stages may be circuits that are part of a single combined circuit. Transmitter 360 comprises also a processor 362 and a memory 364.

Stages 300-304 corresponds directly to stages 200-204 described in association with FIG. 2.

At stage 305 the complex valued modulation symbols are spread using a spreading code to produce a spread signal.

At stage 306 for the spread signal is applied digital-to-analog conversion to produce an analog signal.

At stage 307 the analog signal is modulated to a final transmission radio frequency and transmitted as a radio signal 308. Thereby, the frame F1 is transmitted. It is assumed that receiver 380 detects an error in frame F1 so that the data in frame F1 is later on retransmitted as frame F2 by transmitter 360.

Receiver 380 de-modulates the radio signal 308 at stage 309 to produce an analog signal. Receiver 380 also comprises a processor 382 and a memory 384.

At stage 310 for the analog signal is applied analog-to-digital conversion to produce a spread signal.

At stage 311 rake finger reception is performed for the spread signal. N correlators are assigned to different multipath components. Each finger independently decodes a single multipath component. From stage 311 information is provided for stage 313 which performs channel estimation.

At stage 312 the N fingers are de-spread individually.

At stage 314 the contributions of N fingers are combined using maximum ratio combining to obtain a sequence of complex modulation symbols. From stage 314 the complex modulation symbols are stored to memory 384 to gather information for the frames F1 and F2 as explained in association with FIG. 2.

The stages 316-320 correspond to the respective stages 221-225 explained in association with FIG. 2. The stage 315 corresponds to the stage 220 in FIG. 2.

Transmitter 360 may be comprised in, for ex ample, a mobile node, user equipment, a handset, a cellular phone, a mobile terminal, an Application Specific Integrated Circuit (ASIC), a chip or a chipset.

Receiver 380 may be comprised in, for example, a mobile node, user equipment, a handset, a cellular phone, a mobile terminal, an Application Specific Integrated Circuit (ASIC), a chip or a chipset.

Transmitter 360 and receiver 380 may comprise multiple input or output antennas.

The embodiments of the invention described hereinbefore in association with FIGS. 2 and 3 may be used in any combination with each other. Several of the embodiments may be combined together to form a further embodiment of the invention.

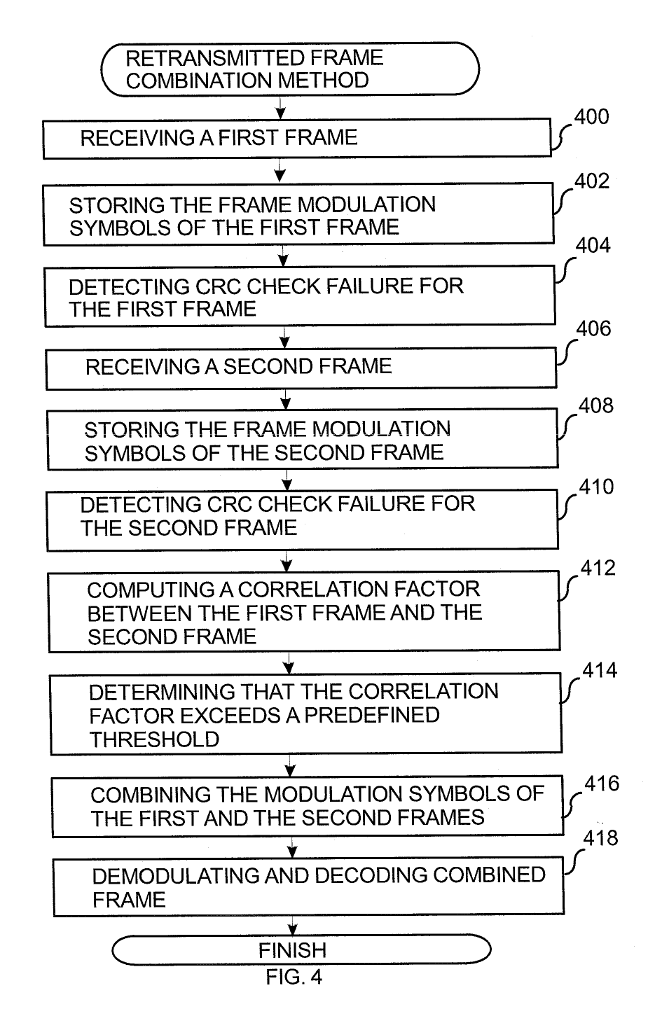

FIG. 4 is a flow chart illustrating a method for combining a retransmitted frame.

At step 400 a first frame is received by a receiving station. The station may be a WLAN station.

At step 402 the modulation symbols of the first frame are stored to a memory in the station.

At step 404 a CRC check failure is detected for the first frame.

At step 406 a second frame is received by the station.

At step 408 the modulation symbols of the second frame are stored to the memory.

At step 410 a CRC check failure is detected for the second frame. Otherwise, the second frame could be provided for a MAC protocol layer entity in the station directly.

At step 412 a correlation factor is computed for the modulation symbols from the first and the second frame.

At step 414 it is determined that the correlation factor exceeds a predefined threshold.

At step 416 is performed a symbol-wise combining of the modulation symbols from the first frame and the second frame to produce a combined frame. The combining may be maximum ratio combining.

At step 418 the demodulation and decoding is performed for the combined frame.

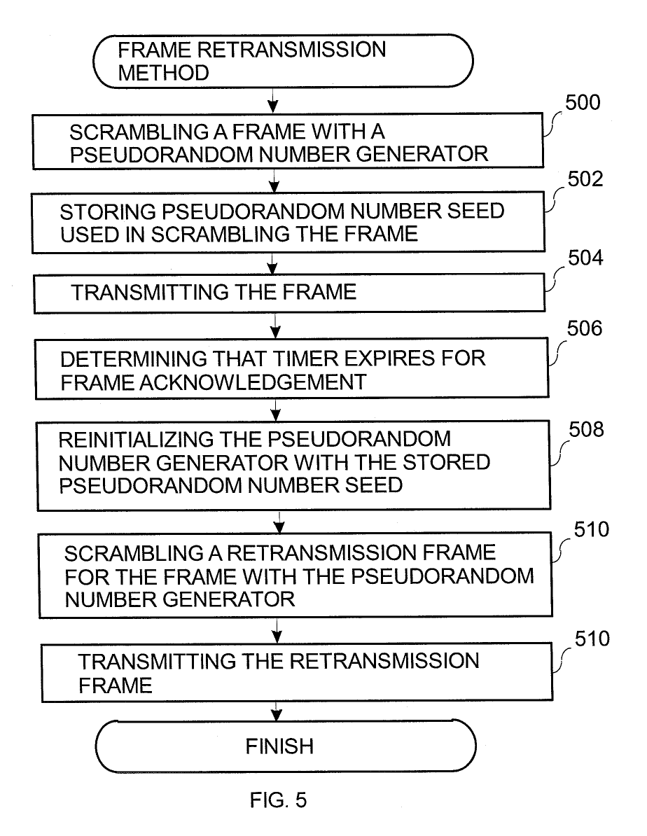

FIG. 5 is a flow chart illustrating a method for frame retransmission. The starting point in FIG. 5 is that a transmitting station obtains a frame for transmission to a receiving station. The frame is stored to a memory of the transmitting station. The transmitting station may be a wireless access point.

At step 500 the frame is scrambled with a pseudorandom number sequence from a pseudorandom number generator in the transmitting station.

At step 502 a pseudorandom number seed used in the scrambling of the frame is stored to the memory in the station.

At step 504 the frame is transmitted by the transmitting station.

At step 506 it is determined that a timer for receiving an acknowledgement for the frame expires.

At step 508 the transmitting station reinitializes the pseudorandom number generator with the stored pseudorandom number seed.

At step 510 the frame is scrambled with the pseudorandom number sequence from the pseudorandom number generator in the transmitting station.

At step 512 the frame is retransmitted from the transmitting station.

The embodiments of the invention described hereinbefore in association with FIGS. 1, 2, 3, 4, 5 and 6 may be used in any combination with each other. Several of the embodiments may be combined together to form a further embodiment of the invention.

The exemplary embodiments of the invention can be included within any suitable device, for example, including any suitable servers, workstations, PCs, laptop computers, PDAs, Internet appliances, handheld devices, cellular telephones, wireless devices, other devices, and the like, capable of performing the processes of the exemplary embodiments, and which can communicate via one or more interface mechanisms, including, for example, Internet access, telecommunications in any suitable form (for instance, voice, modem, and the like), wireless communications media, one or more wireless communications networks, cellular communications networks, 3G communications networks, 4G communications networks Public Switched Telephone Network (PSTNs), Packet Data Networks (PDNs), the Internet, intranets, a combination thereof, and the like.

It is to be understood that the exemplary embodiments are for exemplary purposes, as many variations of the specific hardware used to implement the exemplary embodiments are possible, as will be appreciated by those skilled in the hardware art(s). For example, the functionality of one or more of the components of the exemplary embodiments can be implemented via one or more hardware devices, or one or more software entities such as modules.

The exemplary embodiments can store information relating to various processes described herein. This information can be stored in one or more memories, such as a hard disk, optical disk, magneto-optical disk, RAM, and the like. One or more databases can store the information regarding cyclic prefixes used and the delay spreads measured. The databases can be organized using data structures (e.g., records, tables, arrays, fields, graphs, trees, lists, and the like) included in one or more memories or storage devices listed herein. The processes de scribed with respect to the exemplary embodiments can include appropriate data structures for storing data collected and/or generated by the processes of the devices and subsystems of the exemplary embodiments in one or more databases.

All or a portion of the exemplary embodiments can be implemented by the preparation of one or more application-specific integrated circuits or by interconnecting an appropriate network of conventional component circuits, as will be appreciated by those skilled in the electrical art(s).

As stated above, the components of the exemplary embodiments can include computer readable medium or memories according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of prospective claims.

The embodiments of the invention described hereinbefore may be used in any combination with each other. Several of the embodiments may be combined together to form a further embodiment of the invention. A method, a base station, an apparatus, a computer program, a computer program product or system to which the invention is related may comprise at least one of the embodiments of the invention described hereinbefore.

It is obvious to a person skilled in the art that with the advancement of technology, the basic idea of the invention may be implemented in various ways. The invention and its embodiments are thus not limited to the examples described above; instead they may vary within the scope of the claims.

1. A method, comprising:
receiving a first frame by a wireless receiver;
determining at least two first modulation symbols from at least one first signal carrying the first frame;
storing the at least two first modulation symbols to a memory;
determining a cyclic redundancy check failure for the first frame;
receiving a second frame by the wireless receiver;
determining at least two second modulation symbols from at least one second signal carrying the second frame;
storing the at least two second modulation symbols in the second frame to the memory;
computing a correlation factor between the at least two first modulation symbols and the at least two second modulation symbols;
determining that the correlation factor exceeds a predefined threshold;
performing a symbol-wise combining of the at least two first modulation symbols and the at least two second modulation symbols in order to obtain a combined frame;
demodulating the combined frame; and
determining cyclic redundancy check success for the combined frame.

2. The method according to claim 1, wherein the step of performing the symbol-wise combining of the at least two first modulation symbols and the at least two second modulation symbols comprises the performing of a symbol-wise maximum ratio combining of the at least two first modulation symbols and the at least two second modulation symbols.

3. The method according to claim 1, wherein the step of performing the symbol-wise combining for the at least two first modulation symbols and the at least two second modulation symbols further comprises skipping at least one modulation symbol and taking at least one modulation symbol to the combined frame directly from either the at least two first modulation symbols and the at least two second modulation symbols.

4. The method according to claim 1, the method further comprising:
providing the combined frame from the wireless receiver to at least one processor.

5. The method according to claim 1, wherein the step of determining at least two first modulation symbols from at least one first signal carrying the first frame further comprises:
performing a discrete Fourier transform for the at least one first signal on at least one subcarrier to obtain the at least two first modulation symbols.

6. The method according to claim 5, the method further comprising:
determining a frequency channel response on the at least one subcarrier; and
eliminating the frequency channel response in the symbol-wise combining of the at least two first modulation symbols and the at least two second modulation symbols.

7. The method according to claim 1, the method further comprising:
determining a first frequency channel response associated with a first channel for receiving the first frame;
determining a second frequency channel response associated with a second channel for receiving the second frame; and
eliminating the first frequency channel response and the second frequency channel response in the symbol-wise combining of the at least two first modulation symbols and the at least two second modulation symbols.

8. The method according to claim 1, wherein the wireless receiver is comprised in a wireless local area network station.

9. The method according to claim 1, wherein the wireless receiver is comprised in a wireless local area network wireless access point.

10. The method according to claim 1, wherein the wireless receiver is an Orthogonal Frequency Division Multiple Access receiver.

11. The method according to claim 1, wherein the wireless receiver is a Direct Sequence Spread Spectrum receiver.

12. A method, comprising:
scrambling the frame with a pseudorandom number sequence from a pseudorandom number generator in a wireless transmitter to produce a first scrambled frame;
storing a seed value used in generating the pseudorandom number sequence to a memory;
transmitting the first scrambled frame from the wireless transmitter;
determining timer expiry for an acknowledgement for the scrambled frame in the wireless transmitter;
reinitializing the pseudorandom number generator with the seed value from the memory;
scrambling the frame with the pseudorandom number sequence from the pseudorandom number generator in the wireless transmitter to produce a second scrambled frame; and
transmitting of the second scrambled frame.

13. The method according to claim 12, wherein the transmitter is comprised in a wireless local area network station.

14. The method according to claim 12, wherein the wireless transmitter is comprised in a wireless local area network wireless access point.

15. The method according to claim 12, wherein the wireless transmitter is an Orthogonal Frequency Division Multiple Access receiver.

16. The method according to claim 12, wherein the wireless transmitter is a Direct Sequence Spread Spectrum receiver.

17. A wireless receiver, comprising:
a memory; and
at least one processor configured
to receive a first frame,
to determine at least two first modulation symbols from at least one first signal carrying the first frame,
to store the at least two first modulation symbols to a memory.
to determine a cyclic redundancy check failure for the first frame,
to receive a second frame by the wireless receiver,
to determine at least two second modulation symbols from at least one second signal carrying the second frame,
to store the at least two second modulation symbols in the second frame to the memory,
to compute a correlation factor between the at least two first modulation symbols and the at least two second modulation symbols,
to determine that the correlation factor exceeds a predefined threshold,
to perform a symbol-wise combining of the at least two first modulation symbols and the at least two second modulation symbols in order to obtain a combined frame,
to demodulate the combined frame, and
to determine cyclic redundancy check success for the combined frame.

18. A wireless transmitter, comprising:
a memory; and
at least one processor configured
to scramble the frame with a pseudorandom number sequence from a pseudorandom number generator to produce a first scrambled frame,
to store a seed value used in generating the pseudorandom number sequence to the memory,
to transmit the first scrambled frame,
to determine timer expiry for an acknowledgement for the scrambled frame,
to reinitialize the pseudorandom number generator with the seed value,
to scramble the frame with the pseudorandom number sequence from the pseudorandom number generator to produce a second scrambled frame, and
to transmit the second scrambled frame.

19. (canceled)

20. A computer program tangibly stored on a computer readable medium comprising code adapted to cause the following when executed on a data-processing system:
receiving a first frame by a wireless receiver;
determining at least two first modulation symbols from at least one first signal carrying the first frame;
storing the at least two first modulation symbols to a memory;
determining a cyclic redundancy check failure for the first frame;
receiving a second frame by the wireless receiver;
determining at least two second modulation symbols from at least one second signal carrying the second frame;
storing the at least two second modulation symbols in the second frame to the memory;
computing a correlation factor between the at least two first modulation symbols and the at least two second modulation symbols;
determining that the correlation factor exceeds a predefined threshold;
performing a symbol-wise combining of the at least two first modulation symbols and the at least two second modulation symbols in order to obtain a combined frame;
demodulating the combined frame; and
determining cyclic redundancy check success for the combined frame.

21. (canceled)

22. A computer program tangibly stored on a computer readable medium comprising code adapted to cause the following when executed on a data-processing system:
scrambling the frame with a pseudorandom number sequence from a pseudorandom number generator in a wireless transmitter to produce a first scrambled frame;
storing a seed value used in generating the pseudorandom number sequence to a memory;
transmitting the first scrambled frame from the wireless transmitter;
determining timer expiry for an acknowledgement for the scrambled frame in the wireless transmitter;
reinitializing the pseudorandom number generator with the seed value from the memory;
scrambling the frame with the pseudorandom number sequence from the pseudorandom number generator in the wireless transmitter to produce a second scrambled frame; and
transmitting of the second scrambled frame.

23. (canceled)
